(19) United States
(12) Patent Application Publication
(10) Pub. No.: US 2019/0039121 A1
(43) Pub. Date: Feb. 7, 2019

(54) Binder System For Producing A Slurry And Component Produced Using The Slurry

(71) Applicant: Siemens Aktiengesellschaft, Muenchen (DE)

(72) Inventors: Hermann Bödinger, München (DE); Stefan Denneler, München (DE); Matthias Übler, Ursensollen (DE)

(73) Assignee: Siemens Aktiengesellschaft, Muenchen (DE)

(21) Appl. No.: 16/078,976

(22) PCT Filed: Feb. 7, 2017
(86) PCT No.: PCT/EP2017/052621

§ 371 Date: Aug. 22, 2018

(30) Foreign Application Priority Data
Mar. 1, 2016 (DE) 10 2016 203 313.1

(51) Int. Cl. B22C 9/10; B22C 1/22; B22C 1/18; F01D 5/14; B22C 3/00

(52) U.S. Cl. CPC B22C 9/10; B22C 1/2246; F05D 2230/211; F01D 5/147; B22C 3/00; B22C 1/18

(57) ABSTRACT

The invention relates to a binder system for production of a slip, e.g., for a green casting core compact. The invention also relates to a component that has been produced by means of such a slip. The invention may be employable for relatively inexpensive production of complex metal blades in all kinds of gas turbines and propulsion turbines. According to an embodiment, the invention provides a novel binder system that combines short gel times at room temperature without solvent while retaining a high glass transition of 55 to 60° C. with shortened hardening periods.

### CROSS-REFERENCE TO RELATED APPLICATIONS

This application is a U.S. National Stage Application of International Application No. PCT/EP2017/052621 filed Feb. 7, 2017, which designates the United States of America, and claims priority to DE Application No. 10 2016 203 313.1 filed Mar. 1, 2016, the contents of which are hereby incorporated by reference in their entirety.

### BACKGROUND OF THE INVENTION

The invention relates to a binder system for production of a slip for a green casting core compact. The invention also relates to a component that has been produced by means of such a slip. The invention is especially employable for relatively inexpensive production of complex metal blades in all kinds of gas turbines and propulsion turbines.

In a precision metal casting process, as lost negative molds, ceramic casting cores serve for construction of complex positive geometries, particularly in the representation of microscale-sized surface structures which cannot be produced by conventional milling or machining forms because of undercuts, cavities or tooling-related resolution limits. The process finds application in particular in the more cost-effective production of complex metal blades in gas turbines and propulsion turbines. In order to produce lost casting cores, a technique employed in this case is the slip technique, in which a high-temperature-sinterable powder conglomerate composed of different kinds of inorganic constituents is dispersed in a solvent with two types of binder which build on one another.

This slip is poured into a casting mold for subsequent hardening. This casting mold bears the desired architectural and surface structuring which the ceramic casting core is to adopt in its later state.

Through application of reduced pressure and vibration, the solvent, which serves primarily for reducing viscosity, is stripped off, and at the same time the filler powder fraction is sedimented off and compacted in accordance with the maximum packing density of the powder particle size distribution.

By warm or hot hardening at up to 160° C., the first binder or binder constituent undergoes polymerization, thus giving the resulting green compact the geometry which is to be fixed by sintering later on.

Next, this green compact is freed from the casting mold and then sintered in a stepwise temperature profile to form the ceramic; at up to 300° C., the first binder constituent undergoes pyrolysis and is very largely expelled in the form of gaseous oxidation products. In order that the shape and architecture of the debindered green compact is preserved as what is called a brown compact ahead of the final sintering at high temperatures, a second, high-temperature-resistant binder or binder constituent is commonly used which ensures the shape after debindering. At from about 250° C. to about 500° C., this constituent undergoes consolidation, giving off volatile constituents in so doing. In a final temperature step, high-temperature sintering of the brown compact produces the ceramic which later serves for precision metal casting.

US 20110189440 A1 discloses an overall binder system comprising a combination of anhydrically thermosetting, cycloaliphatic epoxy resin and reactive, methylpolysiloxane-based silicone solid. With addition of dispersion additives, plastifiers (rubber), and solvents (methyl ethyl ketone, isopropyl alcohol or hexane), a slip formulation can be provided which has a high fraction of sintered ceramic powder and is fit for the casting of lost ceramic green cores. The sintered ceramic powder is a multimodal mixture of optimized packing density, composed of amorphous fused silica, cristobalite, magnesium oxide, aluminum oxide, yttrium oxide and zirconium oxide.

Cycloaliphatic epoxy resins are notable for particularly low dynamic viscosities, allowing required solvent contents to be lower. The hardener component of the epoxy resins is commonly an acid anhydride, of the methylhexahydrophthalic acid, methyltetrahydrophthalic acid or methylnadic acid type, for example. These mixtures constitute high-temperature systems which require an accelerator to initiate the polymerization and necessitate hardening temperatures of more than 130° C. over several hours. The reaction shrinkage in US 20110189440 A1 is in the region of up to 5% by volume.

The second binder used for the formation of the brown compact state in US 20110189440 A1 is reactive solid silicone in the form of a polycondensation-crosslinking alkoxyorganopolysiloxane which pyrolyzes under thermal stress to give amorphous quartz. The solid silicon is mixed in here as a loose added powder fraction to the sintered ceramic powder.

Pulverulent silicone resin powder as used according to US 2011/0189440 does not melt until the range from 40° C. to 60° C., such that attainment of mobility suitable for processibility requires temperatures that oppose any later use as layer slip system since the waxes used to form the multiwall casting cores themselves soften in the region of 50° C. Thus, the melting temperature of the brown silicone resin powder compact would coincide with the softening of the template wax, which leads to loss of surface trueness.

A problem for further lowering of the hardening temperatures is that it is then no longer possible to ensure complete polymerization of the added silicone powder with existing formulations. Vulcanization of the silicone powder below 100° C. to give a stiff silicone binder system for fixing of the sintered ceramic powder can be accomplished only unsatisfactorily owing to the underlying chemical mechanism (ethoxy group hydrolysis with subsequent condensation to give a high silicone polymer), since the hydrolysis requires accelerator substances and/or elevated temperatures. This is manifested in reduced stiffness or a low modulus of elasticity of the green compact, but this is disadvantageous, for example, for multiwall ceramic casting cores.

DE 10 2014 219543.8 discloses a novel ceramic powder slip based on epoxy resin/polyaminosilicone resin. This comprises multifunctional epoxy resins of relatively low viscosity and mobile aminosilicone resins, with or without a proportion of solvent. It is disclosed that a stoichiometric epoxy resin/aminosilicone resin binder mixture is usable as ceramic powder slip, which forms a casting core that hardens with a proportion of about 80% by weight of sintered ceramic powder over the course of 18 to 24 hours at 20° C. to 40° C. During the actual casting process, solvent is added here, for example isopropanol and/or methyl ethyl ketone, in order to obtain a usable flowability of the mixture. The hardening to give the green casting core compact is then effected within 24 hours. This green compact has sufficient strength and stiffness to be demolded. This green compact is then sintered to give the ceramic which is used as casting core in precision metal casting for gas turbine blades.

Particular disadvantages of the size system known from DE 10 2014 219543.8 are that it is necessary to use solvents and subsequently remove them again, and that a relatively long hardening or gel time is required at room temperature.

### SUMMARY OF THE INVENTION

It is an object of the present invention to provide a slip, especially one based on ceramic powder, that overcomes the disadvantages of the prior art, reduces the need to add solvent, shows shorter hardening and gel times at room temperature and, in particular, also results in higher strengths in the brittle composites.

This object is achieved by the features of the independent claims. Preferred embodiments can be inferred from the dependent claims in particular.

The object is achieved by a binder system for production of a slip comprising an inorganic constituent, said binder system comprising an epoxy resin and a silicone copolymer, characterized in that a reaction accelerator has been added to the mixture. The object is also achieved by a component produced by means of the slip, in which the green casting core compact is produced using a binder system composed of an epoxy resin and an aminosilicone resin with an inorganic component, to which a reaction accelerator has been added.

The component may especially be a casting mold, especially a casting core for a metallic cast component, for example for a metal blade in gas turbines and propulsion turbines. The casting core may especially be a multiwall casting core.

### DETAILED DESCRIPTION OF THE PREFERRED EMBODIMENTS OF THE INVENTION

In an advantageous embodiment of the invention, the reaction accelerator is used in small amounts of less than 10% by weight, especially less than 5% by weight and more preferably less than/equal to 2% by weight.

In an advantageous embodiment of the invention, the reaction accelerator is selected from the group of the following compounds: imidazoles, mono- and/or disubstituted imidazoles, 1,2-; 1,3-; 1,4-substituted imidazoles, alkyl-substituted imidazoles and/or aryl-substituted imidazoles, especially 1,2-dimethylimidazole.

In an advantageous embodiment of the invention, the reaction accelerator is obtainable by introducing calcium ions into concentrated nitric acid. This accelerator is already effective in very small amounts of less than 2% by weight in the binder, especially in the region of less than 1% by weight, more preferably in the region of less than 0.5% by weight.

In a preferred embodiment of the invention, for production of the slip system, the epoxy resin and the aminosilicone component are used in a ratio in the region of 1.5:0.75 or 0.75:1.5; preferably in a ratio in the region of 0.8:1.2 or vice versa, and especially preferably in a ratio between 0.9:1.1 or vice versa. In a particularly preferred embodiment, the epoxy resin and the aminosilicone component are used in a stoichiometric ratio of 1:1.

This slip has the advantage that, because of the binder thus configured, it ensures complete incorporation of the brown silicone component compact. For consolidation thereof, it requires only very low (consolidation) temperatures and nevertheless has a processing time sufficiently long for production of a body by means of the slip. For example, processing times for the slip of several hours are achievable. It is possible by means of this binder to achieve complete curing at low temperature, such that it is possible to provide flexural strengths or fracture resistances suitable for a further processing chain. Slips produced with these silicone types do not require any further mixing-in of pulverulent silicone since optimal dispersion takes place by virtue of the chemical incorporation in the hardening reaction. In addition, there is advantageously no separation in the course of curing. Moreover, the binder can be provided with a low-viscosity, which facilitates shaping of the slip in a casting mold.

This binder is miscible with standard solvents without breakdown, and in any ratio, but it is advantageous in accordance with the invention to use a minimal amount of solvent to establish the required mobility.

The binder hardens the slip by addition crosslinking virtually without reaction shrinkage to give a stable shaped body.

More particularly, it is possible to achieve consolidation temperatures of not more than 70° C., especially of not more than 60° C., especially of not more than 50° C., especially of not more than 45° C., especially of not more than 40° C., especially of not more than 35° C., especially less than 35° C. This enables the use of alternately applied wax templates for multiwall geometries to be implemented and/or of wax casting molds. The property of low-temperature consolidation, especially hardening, especially permits the construction of multiwall casting cores by use of alternately applied layers of template wax and slip. This process can be used only when the binder polymerizes below the wax melting point to give the shaped body. The melting point of standard waxes is typically 50° C. to 70° C.

However, the slip can also be cast into any desired casting molds, for example into silicone molds etc.

Quite generally, the low curing temperature especially enables an energy saving and particularly simple production, and avoids softening of or even damage to the casting mold, for example to the wax casting mold. Moreover, high precision is achieved owing to low thermal stresses.

The at least one epoxy resin may be one epoxy resin or a mixture of two or more epoxy resins. In general, an epoxy resin may also be understood to mean a parent monomer or oligomer. For example, “bisphenol A diglycidyl ether” or “bisphenol A diglycidyl ether resin” may be understood to mean either the epoxy resin or the parent monomer and/or oligomer. An especially preferred embodiment is that with a triglycidyl ether as epoxy resin, wherein preferably at least a portion of the epoxy resin and preferably the entirety of epoxy resin is a particularly mobile epoxy resin component having a viscosity at room temperature below that of bisphenol A diglycidyl ether. What are meant here are more particularly mobile species such as hydroxyl group-functional di- and/or triglycidyl ethers, for example trimethylolpropane triglycidyl ether and/or glycerol diglycidyl ether.

The binder may especially take the form of a binder matrix comprising the at least one inorganic constituent (for example powder) as filler.

The silicone copolymer is especially a short-chain silicone copolymer. Mobile silicone copolymers are especially advantageous.

The silicone copolymer may especially act as a hardener.

In one configuration, the silicone copolymer used is at least one glycidyl-functional poly(phenyl-methyl)silicone. A substance of this kind or this class of compound has been found to be particularly advantageous for achievement of the above advantages. It may particularly advantageously be extended as desired with epoxy resins or the corresponding monomers and/or oligomers. It may also be extended with amines that are described in detail further down. This substance especially acts as a co-functional hybrid material or hybrid polymer which acts both as a monomer or oligomer for preparation of epoxy resin(s) and as a hardener for epoxy resin. The glycidyl-functional poly(phenyl-methyl)silicone is especially a copolymer partially satisfied with reactive groups with respect to the epoxy resin hardening reaction. Commercially available representatives are, for example, HP-1250 (Wacker Silicones) and Tego Albiflex 348 (Evonik Industries).

In an additional or alternative configuration, the silicone copolymer used is at least one amino-functional poly(phenyl-methyl)silicone. The amino-functional poly(phenyl-methyl)-silicone gives rise to the same advantages as the glycidyl-functional poly(phenyl-methyl)silicone, but has a stronger effect than aminic hardener. This substance too may especially be a copolymer partially satisfied with reactive groups with respect to the epoxy resin hardening reaction. Commercially available representatives of the amino-functional silicone types are, for instance, the HP-2000 and HP-2020 derivatives from Wacker Silicones.

In an advantageous embodiment of the invention, the entirety or a portion of the amino-functional silicone copolymer is replaced by mobile derivatives, the viscosity of which at room temperature is below that of the two abovementioned Wacker silicones, in order that the binder is usable in very substantially solvent-free form. It has been found to be especially advantageous to use the amino-functional silicone types isophoronediamine and/or meta-xylylenediamine.

It has been found to be a development advantageous for attainment of hard and stiff green compacts at low curing temperatures of about 35° C. and with suitable pot lives for the binder to include a blend of amino-functional poly(phenyl-methyl)silicone with epoxy resin.

More particularly, for this purpose, the at least one silicone copolymer may be blended with bisphenol A diglycidyl ether and/or bisphenol F diglycidyl ether, especially in a 10% to 50% (w/w) blend. Thus, a high glass transition range after curing at 35° C. is advantageously attained.

It has been found that, surprisingly, as a result of the use of reaction accelerators, the glass transition of the cured samples remains at an unchanged high level. For example, the glass transition of the samples that have been cured at 35° C. for 18 hours is unchanged within the range from 55° C. to 60° C.

In general, at least one epoxy resin and at least one silicone copolymer may be blended or be in the form of a mixture.

Additionally or alternatively, in general, at least one epoxy resin and at least one silicone copolymer may be in hybrid form or in the form of a hybrid polymer. This may simplify handling. Such a silicone copolymer may thus be mixed with at least one epoxy resin and/or with at least one further silicone copolymer.

In a further configuration, the binder includes at least one amine as additional hardener.

In a further advantageous configuration, at least one reactive diluent (also referred to hereinafter as “RD”), especially at least one epoxidized reactive diluent, is mixed into or has been added to the binder. The at least one reactive diluent brings about an improved dynamic viscosity of the first binder. Correspondingly preformulated products are available, for example, from Huntsman Corporation under the “Araldite LY 1564”, “Araldite LY 1568”, “Araldite GY 793” or “Araldite GY 794” trade names.

In one development, the epoxidic reactive diluent is a monofunctional, bifunctional and/or higher-functionality epoxidic reactive diluent. Reactive diluents used may, for example, be butane-1,4-diol diglycidyl ether, hexane-1,6-diol diglycidyl ether, neopentyl glycol diglycidyl ether, cresyl glycide or the like.

In an additional or alternative configuration, propylene carbonate, butylene carbonate, glycerol carbonate or at least one arbitrary mixture thereof is mixed into the binder, or the binder includes propylene carbonate, butylene carbonate, glycerol carbonate or at least one arbitrary mixture thereof.

The novel compositions comprising silicone copolymer as hardener are soluble without decomposition in the solvents methyl ethyl ketone, acetone and isopropyl alcohol. Therefore, in a further advantageous development, the slip includes methyl ethyl ketone, acetone and/or isopropanol as solvents, or these are mixed into the slip.

The at least one inorganic constituent may include at least one powder or be an inorganic powder constituent. The at least one inorganic constituent may include at least one metallic or ceramic powder, especially sinterable metallic or ceramic powder. Conceivable metallic powders are, for example, powders or powder mixtures of high-melting metals such as tungsten alloys, or else steels and/or hard materials, magnesium oxide, aluminum oxide, yttrium oxide and/or zirconium oxide. In addition to the at least one ceramic powder, the inorganic constituent may include at least one inorganic nonceramic powder, for example amorphous fused silica and/or cristobalite. An at least partly ceramic powder can be used to form a green compact or green body. The at least one powder may have been dispersed in the first binder.

Since a density of the green compact is determined to a significant degree by a maximum packing density of the ceramic powder—especially the dispersed ceramic powder—a maximum theoretical packing coefficient is advantageously at a maximum. By adjustment of multimodalities within the filler fraction, it is known to be possible to increase the packing density. For instance, a monodisperse powder having a Gaussian distribution about a defined particle diameter packs to an extent of about 64% by volume. Addition (“bimodal addition”) of at least one further powder fraction, the particle diameter of which has been chosen such that the interstices or “gaps” between the coarser powder particles are partly filled by the smaller powder particles, results in packing densities of up to 80% by volume. A trimodal powder mixture allows even higher packing densities of up to 95% by volume. Multimodal filler fractions are often employed as sintered powders since, in this way sufficient contacts between adjacent powder particles are generated as to result in a sintered ceramic with a particularly low level of pores. Therefore, in an advantageous configuration, the at least one inorganic constituent has different fractions, especially powder fractions, especially ceramic powder fractions, with mutually multimodal (bimodal, trimodal etc.) particle size distributions.

In percent by weight, according to the present invention, it is possible to achieve filling levels of 60% to 95% by weight, especially 70% to 90% by weight, and more preferably filling levels of 75% by weight up to 85% by weight, in the binder system.

An increase in the maximum packing coefficient of the slip or of a body produced therefrom (especially a green compact, a brown compact or a volume-sintered body) can advantageously be increased by incorporating or introducing inorganic nanoparticles into the slip or as a constituent of the slip. The inorganic nanoparticles can be introduced into the interstitial spaces or gaps of even multimodal powder mixtures. Since inorganic nanoparticles are often in the form of powders that have a tendency to agglomerate and aggregate and can be separated mechanically from one another only with difficulty, dispersion into the first binder in this way is possible only with difficulty and leads to significant rises in viscosity. A remedy is advantageously provided by the use, for example, of colloidally dispersed inorganic amorphous silicon dioxide nanoparticles in solvents. Thus, in a further advantageous configuration, the slip, especially the at least one inorganic constituent therein, includes colloidally disperse, amorphous silicon dioxide nanoparticles, especially as a colloidal solution.

A colloidal solution of this kind is particularly advantageous and stable to agglomeration when the surface of the silicon oxide particles has been covalently coated with an epoxide-compatible adhesion promoter. In this way, even after removal of the solvent, there is no coagulation or aggregation of the nanoscale filler particles.

In one development, the slip includes at least one further binder of high thermal stability. This makes it possible to produce particularly stable brown compacts. The further binder of high thermal stability may especially include or be sinterable silicone, especially condensation-crosslinking solid silicone. The sinterable silicone may especially be in powder form in the slip, especially in the form of a nanoscale powder. One advantage of the sinterable silicone is that it has good solubility in methyl ethyl ketone, acetone and/or isopropyl alcohol, such that it is possible to implement comparatively low solvent contents for establishment of optimal flow properties with dissolution of all binder constituents. This too is an advantage of the use of the solvents methyl ethyl ketone, acetone and/or isopropyl alcohol.

The above-described properties, features and advantages of this invention and the manner in which they are achieved become clearer and more distinctly apparent in connection with the schematic description of a working example which follows.

A binder system known from DE 10 2014 219543.8, the content of which is hereby incorporated into the present disclosure, composed of 3.35 g of trifunctional epoxy resin and 8.65 g of xylene-containing aminosilicone resin was used in the form of a 1:1 stoichiometry base mixture.

To accelerate the hardening, this mixture was mixed with 2.5% by weight and 5% by weight of liquid 1,2-dimethylimidazole. 1,2-Dimethylimidazole (“RB1”) as supplied is a solid, but can be melted at 50° C. to give a phase which is mobile at room temperature. Substitution of 5% by weight of the 1:1 stoichiometric base mixture for 1,2-dimethylimidazole (anionic acceleration) leads to only slight shortening of the gel times at, for example, 35° C. (six hours to about five hours), but leads to a significant acceleration of hardening, detectable by means of DMTA analysis as a rise in the storage modulus E′ by up to 20% (0% 1,2-dimethylimidazole: 4415 MPa; 5% 1,2-dimethyl-imidazole 5234 MPa). At the same time, the glass transition of the samples that have been hardened at 35° C. for 18 hours is unchanged within the range of 55-60° C.

At room temperature, these samples are subject to significant further hardening, such that a rest phase of an additional 24 hours leads to green compacts having marked stiffness. After 20 days at room temperature, the storage moduli of the 1,2-dimethylimidazole-free composites have virtually doubled (8579 MPa). A further means of significantly accelerating gelation is achievable by addition of very small amounts of a mixture of calcium ions in concentrated nitric acid (“RB2”). According to the invention, this accelerator may accordingly be prepared, for example, from 6.206 g of calcium nitrate tetrahydrate and 2.400 g of 55% nitric acid, and exerts significant acceleration activity on the epoxy/amine binder system mentioned. Thus, base mixture at 23° C., according to addition of accelerator, exhibits a gel time according to gel standard (12 g) in [hh:mm] of

| | |
|---|---|
| 0.000% | RB2: 07:38 |
| 0.125% | RB2: 06:28 |
| 0.250% | RB2: 05:17 |
| 0.500% | RB2: 03:21 |
| 1.000% | RB2: 01:18 |

For altering toughness/stiffness, the replacement of the epoxy and/or amine component with various compounds has been found to be productive. For instance, the abovementioned base mixture of trifunctional epoxy resin and xylene-containing aminosilicone resin can be made less crack-sensitive when a portion or the entirety of trifunctional epoxy resin is replaced by a markedly more mobile species such as trimethylolpropane triglycidyl ether and/or glycerol diglycidyl ether.

To increase the stiffness, in the base mixture of trifunctional epoxy resin and xylene-containing aminosilicone resin, the proportion of aminosilicone resin can be replaced by mobile derivatives such as isophoronediamine and/or meta-xylylenediamine.

Even though the invention has been illustrated in detail and described by the working example shown, the invention is not restricted thereto, and other variants may be inferred therefrom by the person skilled in the art without leaving the scope of protection of the invention.

In general, “a” or “one” may be understood to mean one or more items, especially in the context of “at least one” or “one or more” etc., unless this is explicitly ruled out, for example by the expression “exactly one” etc.

A numerical figure may also encompass exactly the specified number and also a customary tolerance range, unless this is explicitly ruled out.

In general, in the process, mixing or combining may also encompass providing of a previously mixed or combined formulation or composition, and vice versa. For example, the feature that “at least one epoxidized reactive diluent is mixed into the binder” may encompass mixing of these constituents by a user of the process, and also utilization of a correspondingly preformulated composition by the user.

What is claimed is:

1. A binder system for the production of a slip comprising an inorganic constituent, the binder system comprising
an epoxy resin;
a silicone copolymer; and
a reaction accelerator.

2. The binder system as claimed in claim 1, wherein the binder system comprises up to 10% by weight reaction accelerator.

3. The binder system as claimed in claim 1, wherein the reaction accelerator is selected from the group consisting of imidazoles, mono- and/or disubstituted imidazoles, 1,2-; 1,3-; 1,4-substituted imidazoles, alkyl-substituted imidazoles, aryl-substituted imidazoles, 1,2-dimethylimidazole and mixtures thereof.

4. The binder system as claimed in claim 1, wherein the reaction accelerator is obtained by introducing calcium ions into concentrated nitric acid.

5. The binder system as claimed in claim 4, wherein the binder system comprises up to 2% by weight reaction accelerator.

6. The binder system as claimed in claim 1, wherein the epoxy resin component and the silicone copolymer are present in the binder system in a ratio of 1.5:0.7 to 0.7:1.5.

7. The binder system as claimed in claim 1, wherein the epoxy resin component and the silicone copolymer are present in the binder system in a stoichiometric ratio of 1:1.

8. The binder system as claimed in claim 1, wherein at least part of the epoxy resin component is a mobile epoxy resin component having a viscosity at room temperature below that of bisphenol A diglycidyl ether.

9. The binder system as claimed in claim 1, wherein the epoxy resin component at least partly comprises a compound selected from the group of the compounds consisting of trimethylolpropane triglycidyl ether, glycerol diglycidyl ether and mixtures thereof.

10. The binder system as claimed in claim 1, wherein the silicone copolymer component is an amino-functional silicone copolymer component.

11. The binder system as claimed in claim 1, wherein the amino-functional silicone component is more mobile than an amino-functional poly(phenyl-methyl) silicone.

12. The binder system as claimed in claim 1, wherein an inorganic constituent is in multimodal form.

13. The binder system as claimed in claim 1, wherein the inorganic constituent is in the form of nanoparticles.

14. The binder system as claimed in claim 1, wherein the inorganic constituent is present in an amount of up to 95% by weight of the slip.

15. A component producible by means of a slip comprising a binder system as claimed in claim 1 by sintering.

16. A binder system for the production of a slip comprising an inorganic constituent, the binder system comprising
an epoxy resin comprising trimethylolpropane triglycidyl ether and/or glycerol diglycidyl ether;
an amino-functional silicone copolymer; and
up to 10% by weight reaction accelerator selected from the group consisting of imidazoles, mono- and/or disubstituted imidazoles, 1,2-; 1,3-; 1,4-substituted imidazoles, alkyl-substituted imidazoles, aryl-substituted imidazoles, 1,2-dimethylimidazole and mixtures thereof.

17. The binder system of claim 16, wherein the epoxy resin component and the silicone copolymer are present in the binder system in a ratio of 1.5:0.7 to 0.7:1.5.

18. The binder system of claim 16, wherein the epoxy resin component and the silicone copolymer are present in the binder system in a stoichiometric ratio of 1:1.

19. The binder system as claimed in claim 16, wherein the amino-functional silicone component is more mobile than an amino-functional poly(phenyl-methyl) silicone.

20. The binder system of claim 16, wherein the binder system comprises up to 2% by weight reaction accelerator.

21. The binder system of claim 16, wherein the inorganic constituent is in the form of nanoparticles.
